(19) United States
(12) Patent Application Publication
(10) Pub. No.: US 2026/0370431 A1
(43) Pub. Date: Nov. 19, 2026

(54) FREQUENCY-DOMAIN COMB RESOURCE ALLOCATION AND MULTIPLEXING METHODS

(71) Applicant: ZTE CORPORATION, Shenzhen (CN)

(72) Inventors: Yihua MA, Shenzhen (CN); Zhifeng YUAN, Shenzhen (CN); Yu XIN, Shenzhen (CN); Guanghui YU, Shenzhen (CN)

(21) Appl. No.: 19/470,639

(22) PCT Filed: Apr. 17, 2023
(86) PCT No.: PCT/CN2023/088732

§ 371 Date: Sep. 29, 2025

(51) Int. Cl. H04L 5/00

(52) U.S. Cl. CPC H04L 5/0094; H04L 5/001

(57) ABSTRACT

A wireless communication method for use in a first wireless device is disclosed. The method comprises transmitting, to a second wireless device, a first wireless signal in at least one first sub-carrier every M sub-carriers, wherein M is an integer greater than 1, wherein a position of the at least one first sub-carrier within the M sub-carriers is fixed.

This document is directed generally to wireless communications, and in particular to 5G communications.

OFDM (Orthogonal frequency-division multiplexing) is able to deal with frequency-selective channels, by converting time-domain convolutions of multiple paths into simple dot products. However, OFDM cannot deal with doubly-selective channels which are both time-selective and frequency-selective.

For doubly-selective channels, OTFS (Orthogonal Time Frequency & Space) may be used to support the data transmission over doubly-selective channel. However, the complexity of OTFS is significantly high, which limits the application of OTFS in practice.

This document relates to methods, systems, and devices for the date transmission, an in particular to methods, systems, and devices for the data transmission in high mobility scenarios.

The present disclosure relates to a wireless communication method for use in a first wireless device. The method comprises:
transmitting, to a second wireless device, a first wireless signal in at least one first sub-carrier every M sub-carriers, wherein M is an integer greater than 1.

Various embodiments may preferably implement the following features:

Preferably, a position of the at least one first sub-carrier within the M sub-carriers is fixed. The position may be a relative position, e.g., a relative position of the at least one first sub-carrier with respect to and within the M sub-carriers. Thus, in the embodiments of the present disclosure, position and relative position may be used interchangeably.

Preferably, the wireless communication method further comprises transmitting, to the second wireless device, comb resource allocation information associated with the at least one first sub-carrier.

Preferably, the comb resource allocation configuration information comprises at least one of:
a comb size, configured to indicate a value of M,
a start sub-carrier set, configured to indicate at least one index for a starting set of the at least one first sub-carrier, or
an effective sub-carrier number, configured to indicate a number of the first sub-carriers.

Preferably, the comb resource allocation configuration information comprises at least one of:
a comb size, configured to indicate a value of M,
a start physical resource block (PRB), configured to indicate a first PRB comprising the at least one first sub-carrier,
a PRB length, configured to indicate a number of PRBs comprising the at least one first sub-carrier, or
a sub-carrier offset, configured to indicate the position of the at least one first sub-carrier within the M sub-carriers.

Preferably, the comb resource allocation configuration information is transmitted in downlink control information.

Preferably, the first wireless signal comprises physical downlink shared channel resource elements or physical uplink shared channel resource elements.

Preferably, the wireless communication method further comprises transmitting, to a third wireless device, a second wireless signal in at least one second sub-carrier every N sub-carriers, wherein N is an integer greater than 1.

Preferably, a position of the at least one second sub-carrier within the N sub-carriers is fixed.

Preferably, the first sub-carrier is different from the second sub-carrier.

Preferably, M is the same or different from N.

Preferably, the wireless communication method further comprises transmitting a reference signal in at least one third sub carrier within every K sub-carriers, wherein K is an integer greater than 1.

Preferably, a position of the at least one third sub-carrier within the K sub-carriers is fixed.

Preferably, the reference signal is for single wireless device or multiple wireless devices.

The present disclosure relates to a wireless communication method for use in a second wireless device. The method comprises:
receiving, from a first wireless device, a first wireless signal in at least one first sub-carrier every M sub-carriers, wherein M is an integer greater than 1.

Various embodiments may preferably implement the following features:

Preferably, a position of the at least one first sub-carrier within the M sub-carriers is fixed.

Preferably, the wireless communication method further comprises receiving, from the first wireless device, comb resource allocation configuration information associated with the at least one first sub-carrier.

Preferably, the comb resource allocation configuration information comprises at least one of:
a comb size, configured to indicate a value of M,
a start sub-carrier set, configured to indicate at least one index for a starting set of the at least one first sub-carrier, or
an effective sub-carrier number, configured to indicate a number of the first sub-carriers.

Preferably, the comb resource allocation configuration information comprises at least one of:
a comb size, configured to indicate a value of M,
a start physical resource block (PRB), configured to indicate a first PRB comprising the at least one first sub-carrier,
a PRB length, configured to indicate a number of PRBs comprising the at least one first sub-carrier, or
a sub-carrier offset, configured to indicate the position of the at least one first sub-carrier within the M sub-carriers.

Preferably, the comb resource allocation configuration information is transmitted in downlink control information.

Preferably, the first wireless signal comprises physical downlink shared channel resource elements or physical uplink shared channel resource elements.

Preferably, the wireless communication method further comprises receiving, from the first wireless device, a reference signal in at least one third sub carrier every K sub-carriers, wherein K is an integer greater than 1.

Preferably, a position of the at least one third sub-carrier within the K sub-carriers is fixed.

Preferably, the reference signal is for single wireless device or multiple wireless devices.

The present disclosure relates to a first wireless device. The first wireless device comprises:
a communication unit, configured to transmit, to a second wireless device, a first wireless signal in at least one first sub-carrier every M sub-carriers, wherein M is an integer greater than 1.

Various embodiments may preferably implement the following feature:

Preferably, the first wireless device further comprises a processor configured to perform any of the aforementioned wireless communication methods.

The present disclosure relates to a second wireless device. The second wireless device comprises:
a communication unit, configured to receive, from a first wireless device, a first wireless signal in at least one first sub-carrier every M sub-carriers, wherein M is an integer greater than 1.

Various embodiments may preferably implement the following features:

Preferably, the second wireless device further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

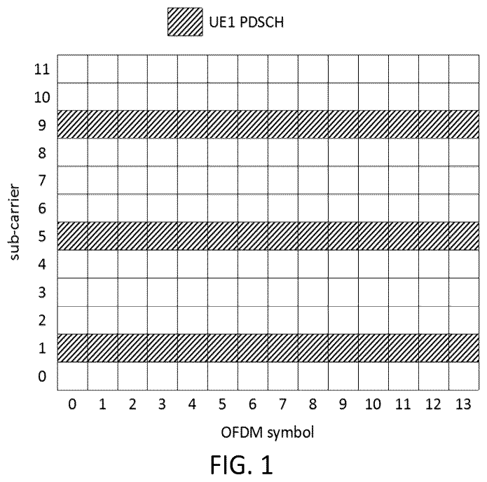

FIG. 1 shows a schematic diagram of a wireless signal according to an embodiment of the present disclosure.

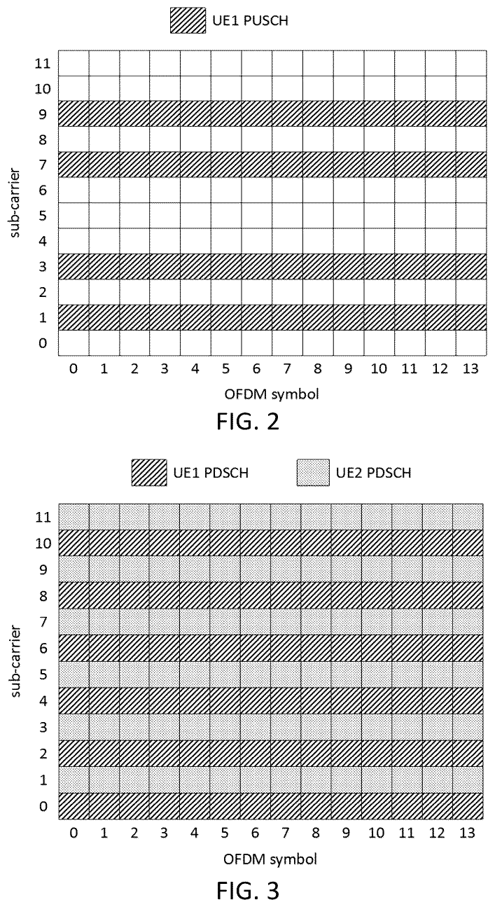

FIG. 2 shows a schematic diagram of a wireless signal according to an embodiment of the present disclosure.

FIG. 3 shows a schematic diagram of a wireless signal according to an embodiment of the present disclosure.

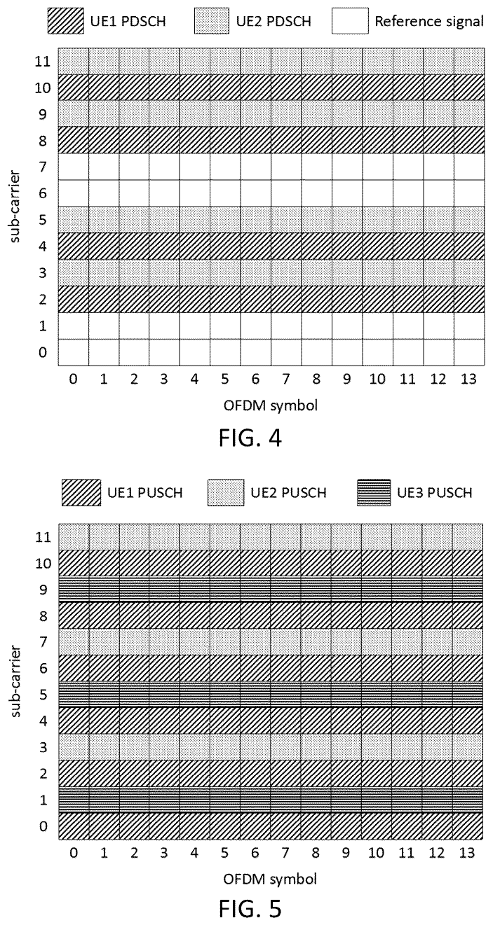

FIG. 4 shows a schematic diagram of a wireless signal according to an embodiment of the present disclosure.

FIG. 5 shows a schematic diagram of a wireless signal according to an embodiment of the present disclosure.

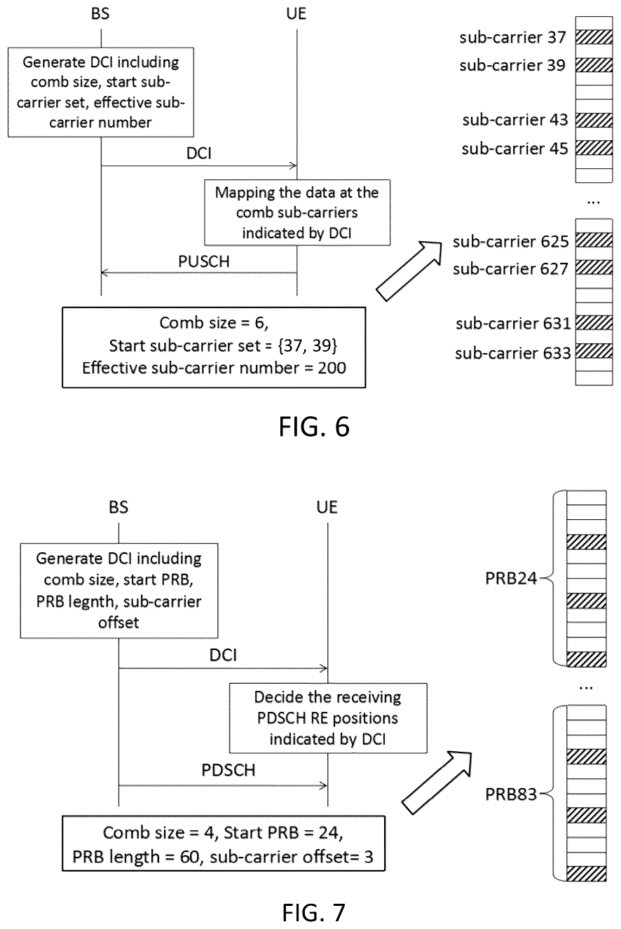

FIG. 6 shows a schematic diagram of a procedure according to an embodiment of the present disclosure.

FIG. 7 shows a schematic diagram of a procedure according to an embodiment of the present disclosure.

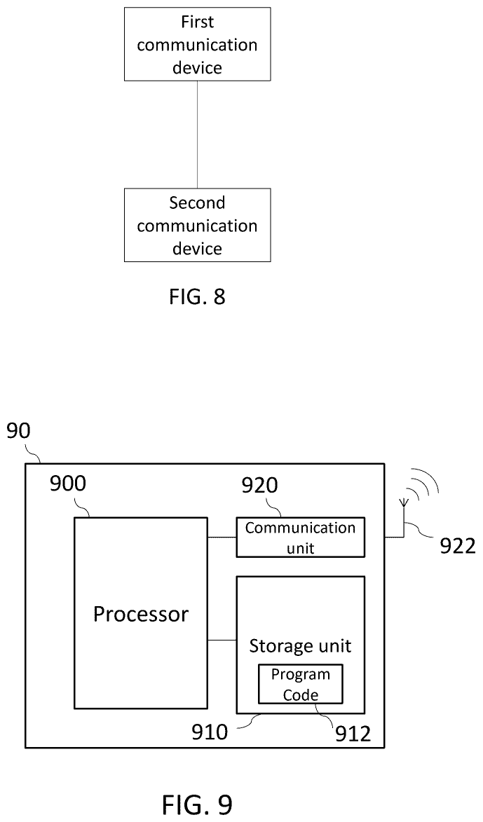

FIG. 8 shows a schematic diagram of a network (architecture) according to an embodiment of the present disclosure.

FIG. 9 shows an example of a schematic diagram of a wireless terminal according to an embodiment of the present disclosure.

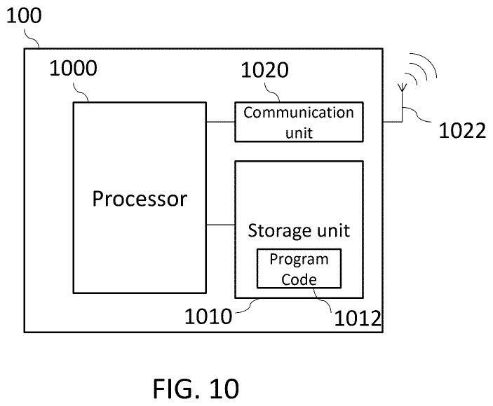

FIG. 10 shows an example of a schematic diagram of a wireless network node according to an embodiment of the present disclosure.

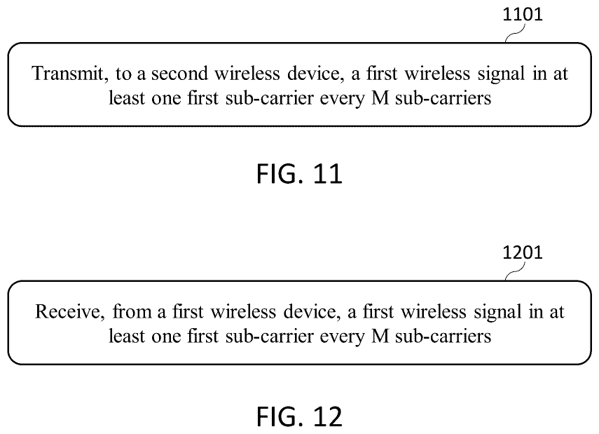

FIG. 11 shows a flowchart of a method according to an embodiment of the present disclosure.

FIG. 12 shows a flowchart of a method according to an embodiment of the present disclosure.

In an embodiment of low-mobility scenarios, the OFDM frequency-selectivity varies slowly, which is very helpful for user scheduling, and the user can be scheduled in the sub-carriers with high channel gain. In an embodiment of high-mobility scenarios, the OFDM frequency-selectivity varies very fast which makes the user scheduling very difficult. In the present disclosure, frequency-comb multiplexing methods are proposed, e.g., to gain a more stable channel gain in the high-mobility scenario.

FIG. 1 shows a schematic diagram of a wireless signal according to an embodiment of the present disclosure. In this embodiment, a frequency domain comb resource pattern is disclosed. Specifically, a BS (base station) transmits a wireless signal to a UE (user equipment) UE1 over a PDSCH (physical downlink shared channel). As shown in FIG. 1, a comb size of the frequency domain comb resource pattern for the PDSCH of the UE1 is 4. The PDSCH REs for the UE1 locate in the second sub carrier of every 4 sub-carriers. In an embodiment, the PDSCH resource allocation information associated with the frequency domain comb resource pattern is sent to the UE1.

FIG. 2 shows a schematic diagram of a wireless signal according to an embodiment of the present disclosure. In this embodiment, a frequency domain comb resource pattern is disclosed. In particular, a UE1 transmits a wireless signal to a BS over a PUSCH (physical uplink shared channel). As shown in FIG. 2, the comb size of the frequency domain comb resource pattern is 6. In the frequency domain comb resource pattern, the PUSCH REs locate in the second and the fourth sub-carriers within every 6 sub-carriers. In an embodiment, before the transmission, the resource allocation information is sent to the UE.

FIG. 3 shows a schematic diagram of a wireless signal according to an embodiment of the present disclosure. In this embodiment, a frequency domain comb resource pattern is disclosed. Specifically, a BS transmits a wireless signal to two UEs UE1 and UE2 over the PDSCH. As shown in FIG. 3, the comb size of both UEs is 2. The PDSCH REs for the UE1 locate in the first sub-carrier of every 2 sub-carriers, while the PDSCH REs for the UE2 locate in the second sub-carrier of every 2 sub-carriers. In an embodiment, the PDSCH DMRS (demodulation reference signal) is in the PDSCH REs for the UE1 and the PDSCH DMRS for the UE 2 is in the PDSCH REs for the UE2. That is, the PDSCH REs for the UE2 may be considered as a guard band for the PDSCH DMRS for the UE1. Similarly, the PDSCH REs for the UE1 may be considered as a guard band for the PDSCH DMRS for the UE2. In an embodiment, before the transmission, the PDSCH resource allocation information is sent to both UE1 and UE2.

FIG. 4 shows a schematic diagram of a wireless signal according to an embodiment of the present disclosure. In this embodiment, a frequency domain comb resource pattern is disclosed. In FIG. 4, a BS transmits the wireless signal to the UE1 and UE2 over/on a PDSCH. As shown in FIG. 4, the comb size of the frequency domain comb resource pattern is 2. The PDSCH REs for the UE1 locate in the first sub-carrier of every 2 sub-carriers, while the PDSCH REs for the UE2 locate in the second sub-carrier of every 2 sub-carriers. Note that, in FIG. 4, certain sub-carriers are used by reference signal(s) of the PDSCH for both the UE1 and the UE2, rather than UE-specific reference signal. In an embodiment, before the transmission, the PDSCH resource allocation information is sent to both the UE1 and UE2.

FIG. 5 shows a schematic diagram of a wireless signal according to an embodiment of the present disclosure. In this embodiment, a frequency domain comb resource pattern is disclosed. In FIG. 5, a BS receives the wireless signal from three UEs UE1, UE2 and UE3 over a PUSCH. As shown in FIG. 5, the comb size of the frequency domain comb resource pattern for the UE1 is 2, while the comb size of the frequency domain comb resource patterns for the UE2 and the UE3 is 4. The PUSCH REs for the UE1 locate in the first subcarrier of every 2 sub-carriers, the PUSCH RES for the UE2 locate in the fourth sub-carrier of every 4 sub-carriers, and the PUSCH REs for the UE3 locate in the second sub-carrier of every 4 sub-carriers. In another aspect, the comb size of the frequency domain comb resource patterns for all of UE1, UE2 and UE3 is 4. The PUSCH REs for the UE1 locate in the first subcarrier and the third sub-carrier of every 4 sub-carriers, the PUSCH REs for the UE2 locate in the fourth sub-carrier of every 4 sub-carriers, and the PUSCH REs for the UE3 locate in the second sub-carrier of every 4 sub-carriers. In an embodiment, before the transmission, the PUSCH resource allocation information is sent to all UEs.

FIG. 6 shows a schematic diagram of a procedure according to an embodiment of the present disclosure. In this embodiment, the procedure for a frequency domain comb resource allocation is disclosed. In FIG. 6, a BS generates DCI (downlink control information) which includes at least one of a comb size, a start sub-carrier set, or an effective sub-carrier number. The BS transmits the DCI to a UE. The UE maps the transmitted data into the corresponding sub-carriers according to the DCI and transmits the signal over the PUSCH. FIG. 6 also shows an exemplified allocated frequency domain resource if the comb size=6, the start sub-carrier set={37, 39}, and the effective sub-carrier number=200.

FIG. 7 shows a schematic diagram of a procedure according to an embodiment of the present disclosure. In this embodiment, the procedure for the frequency domain comb resource allocation is disclosed. In FIG. 7, a BS generates the DCI which includes at least one of the comb size, a start PRB, a PRB length or a sub-carrier offset and transmits the DCI to a UE. The UE decides/determined corresponding PDSCH RE positions according to the DCI and receives the PDSCH in the decided/determined time-frequency positions. FIG. 7 shows an example of the allocated frequency domain resource if the comb size=4, the start PRB=24, the PRB length=60, and the sub-carrier offset=3.

FIG. 8 shows a schematic diagram of a network (architecture) according to an embodiment of the present disclosure. The network (architecture) shown in FIG. 8 comprises a first communication device and a second communication device. In an embodiment, the second communication device may be a UE, a wireless terminal, a wireless device, a wireless node, etc. and the first communication device may be a BS, a gNB, an eNB, a repeater, a relay and so on.

In an embodiment, a transmitting node (e.g., the first communication device) transmits a wireless signal to a receiving node (e.g., the second communication device). In this embodiment, the wireless signal uses m sub-carrier(s) every M sub-carriers, where 1≤m<M. In an embodiment, the relative position(s) of the m sub-carrier(s) in/within the M sub-carriers is fixed. In an embodiment, M is the comb size for (the wireless signal transmitted to) the receiving device.

Note that, the relative position(s) of the m sub-carrier(s) in/within the M sub-carriers refers to position(s) of the m sub-carrier(s) relative to a reference position associated with the M sub-carriers (e.g., the bottom sub-carrier in the frequency domain) or to position(s) of the m sub-carrier(s) within the M sub-carriers. For example, the m sub-carrier in/within the M sub-carriers may be the first/second/third/fourth sub-carrier (from bottom to top in the frequency domain) in/within the M sub-carriers, where m=1 and M=4. That is the relative position(s) of the m sub-carrier in/within the M sub-carriers may be 0/1/2/3 or 1/2/3/4 relative to the bottom sub-carrier of the M=4 sub-carriers.

In an embodiment, the transmitting node (e.g., the first communication device) transmits a plurality of wireless signals to a plurality of receiving nodes (e.g., multiple second communication devices). In this embodiment, the wireless signal between the transmitting node and i-th receiving node uses mᵢ sub-carrier(s) every M sub-carriers, where 1≤mᵢ<M. The relative position(s) of mᵢ sub-carrier(s) in every M sub-carriers is fixed. In an embodiment, M is the comb size for (the plurality of wireless signals transmitted to) the plurality of receiving nodes.

In an embodiment, the transmitting node (e.g., the first communication device) transmits a plurality of wireless signals to a plurality of receiving nodes. In this embodiment, the wireless signal between the transmitting node and the i-th receiving node uses mᵢ sub-carriers every Mᵢ sub-carriers, where 1≤mᵢ<Mᵢ. The relative position(s) of mᵢ sub-carrier(s) in every Mᵢ sub-carriers is fixed. In an embodiment, Mᵢ is the comb size for (the wireless signal transmitted to) the i-th receiving node.

In an embodiment, the wireless signal transmitted by the transmitting node may be/comprise a reference signal. The reference signal may be specific/dedicated to one user (e.g., receiving node) or shared between a plurality of users (e.g., receiving nodes).

In an embodiment, before the transmission of the wireless signal, the frequency-domain comb resource allocation configuration is sent to the receiving node in the downlink.

For example, the frequency-domain comb resource allocation configuration is included in DCI (downlink control information).

In an embodiment, the frequency-domain comb resource allocation configuration includes at least one of a comb size, a start sub-carrier set, an effective sub-carrier number, a start PRB (physical resource block), a PRB length, or a sub-carrier offset.

FIG. 9 relates to a schematic diagram of a wireless terminal 90 according to an embodiment of the present disclosure. The wireless terminal 90 may be a user equipment (UE), a mobile phone, a laptop, a tablet computer, an electronic book or a portable computer system and is not limited herein. The wireless terminal 90 may include a processor 900 such as a microprocessor or Application Specific Integrated Circuit (ASIC), a storage unit 910 and a communication unit 920. The storage unit 910 may be any data storage device that stores a program code 912, which is accessed and executed by the processor 900. Embodiments of the storage unit 910 include but are not limited to a subscriber identity module (SIM), read-only memory (ROM), flash memory, random-access memory (RAM), hard-disk, and optical data storage device. The communication unit 920 may a transceiver and is used to transmit and receive signals (e.g., messages or packets) according to processing results of the processor 900. In an embodiment, the communication unit 920 transmits and receives the signals via at least one antenna 922 shown in FIG. 9.

In an embodiment, the storage unit 910 and the program code 912 may be omitted and the processor 900 may include a storage unit with stored program code.

The processor 900 may implement any one of the steps in exemplified embodiments on the wireless terminal 90, e.g., by executing the program code 912.

The communication unit 920 may be a transceiver. The communication unit 920 may as an alternative or in addition be combining a transmitting unit and a receiving unit configured to transmit and to receive, respectively, signals to and from a wireless network node (e.g., a base station).

FIG. 10 relates to a schematic diagram of a wireless network node 100 according to an embodiment of the present disclosure. The wireless network node 100 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 100 may comprise (perform) at least one network function such as an access and mobility management function (AMF), a session management function (SMF), a user place function (UPF), a policy control function (PCF), an application function (AF), etc. The wireless network node 100 may include a processor 1000 such as a microprocessor or ASIC, a storage unit 1010 and a communication unit 1020. The storage unit 1010 may be any data storage device that stores a program code 1012, which is accessed and executed by the processor 1000. Examples of the storage unit 1010 include but are not limited to a SIM, ROM, flash memory, RAM, hard-disk, and optical data storage device. The communication unit 1020 may be a transceiver and is used to transmit and receive signals (e.g., messages or packets) according to processing results of the processor 1000. In an example, the communication unit 1020 transmits and receives the signals via at least one antenna 1022 shown in FIG. 10.

In an embodiment, the storage unit 1010 and the program code 1012 may be omitted. The processor 1000 may include a storage unit with stored program code.

The processor 1000 may implement any steps described in exemplified embodiments on the wireless network node 100, e.g., via executing the program code 1012.

The communication unit 1020 may be a transceiver. The communication unit 1020 may as an alternative or in addition be combining a transmitting unit and a receiving unit configured to transmit and to receive, respectively, signals to and from a wireless terminal (e.g., a user equipment or another wireless network node).

FIG. 11 shows a schematic diagram of a method according to an embodiment of the present disclosure. The method shown in FIG. 11 may be used in a first wireless device and comprises the following step:
Step 1101: Transmit, to a second wireless device, a first wireless signal in at least one first sub-carrier every M sub-carriers.

In this embodiment, the first wireless device transmits a first wireless signal in at least one first sub-carrier every M sub-carriers to a second wireless device, wherein M is an integer greater than 1. Note that a (relative) position of the at least one first sub-carrier within the M sub-carriers is fixed. In an embodiment, M may represent the comb size for the first wireless signal. For example, the first wireless signal may be transmitted in the 1st sub-carrier (i.e., first sub-carrier) every 4 sub-carriers (second sub-carriers). That is the sub-carriers in which the first wireless signal is transmitted form a comb structure/pattern. In an embodiment, there are an offset between every two adjacent resource elements of the first wireless signal in the same time-domain position (e.g., symbol).

In an embodiment, the first wireless device transmits comb resource allocation information associated with the at least one first sub-carrier (e.g., associated with the comb structure) to the second wireless device.

In an embodiment, the comb resource allocation configuration information comprises at least one of:
a comb size, configured to indicate a value of M;
a start sub-carrier set, configured to indicate at least one index for a starting set of the at least one first sub-carrier, or
an effective sub-carrier number, configured to indicate a number of the first sub-carriers.

As an alternative, the comb resource allocation configuration information comprises at least one of:
a comb size, configured to indicate a value of M,
a start PRB, configured to indicate a first PRB comprising the at least one first sub-carrier,
a PRB length, configured to indicate a number of PRBs comprising the at least one first sub-carrier, or
a sub-carrier offset, configured to indicate the position of the at least one first sub-carrier within the M sub-carriers.

In an embodiment, the comb resource allocation configuration information is transmitted in DCI.

In an embodiment, the first wireless signal comprises PDSCH REs or PUSCH REs. That is the first wireless signal may carry (only) data.

In an embodiment, the first wireless device may transmit a second wireless signal in at least one second sub-carrier every a N sub-carriers to a third wireless device, where N is an integer greater than 1. In this embodiment, a position of the at least one second sub-carrier within the N sub-carriers is fixed and the first sub-carrier is different from the second sub-carrier. Note that N may represent the comb size for the third wireless signal.

In an embodiment, M may be the same with N. In other words, the comb size for the first wireless signal may be the same with that for the second wireless signal. For example, the first wireless signal may be transmitted on the 1st sub-carrier every M=4 sub-carriers and the second wireless signal may be transmitted on the 3rd sub-carrier every N=4 sub-carriers.

In an embodiment, M may be different from N. That is the comb size of the first wireless signal may be different from that of the second wireless signal. For instance, the first wireless signal may be transmitted on the 1st sub-carrier every M=2 sub-carriers and the second wireless signal may be transmitted on the 4th sub-carrier every N=4 sub-carriers.

In an embodiment, the first wireless device may transmit a reference signal in at least one third sub carrier every K sub-carriers, where K is an integer greater than 1. In this embodiment, a (relative) position of the at least one third sub-carrier within the K sub-carriers is also fixed. In an embodiment, the third sub-carrier(s) is(are) different from the first sub-carrier(s) (and the second sub-carrier(s) if the second wireless signal is transmitted). That is the reference signal may not overlap with other wireless signals. Note that K may represent the comb size for the reference signal.

In an embodiment, the reference signal may be (dedicated) for single wireless device or shared by multiple wireless devices.

FIG. 12 shows a schematic diagram of a method according to an embodiment of the present disclosure. The method shown in FIG. 12 may be used in a second wireless device and comprises the following step:
Step 1201: Receive, from a first wireless device, a first wireless signal in at least one first sub-carrier every M sub-carriers.

In FIG. 12, the second wireless device receives a first wireless signal in at least one first sub-carrier every M sub-carriers from a first wireless device, wherein M is an integer greater than 1. In this embodiment, a (relative) position of the at least one first sub-carrier within the M sub-carriers is fixed. Note that M may represent the comb size for the first wireless signal. For example, the first wireless signal may be received in the 1st sub-carrier (i.e., first sub-carrier) every 4 sub-carriers (second sub-carriers). That is the sub-carriers in which the first wireless signal is received form a comb structure.

In an embodiment, the second wireless device receives comb resource allocation information associated with the at least one first sub-carrier (e.g., associated with the comb structure) from the first wireless device.

In an embodiment, the comb resource allocation configuration information comprises at least one of:
a comb size, configured to indicate a value of M;
a start sub-carrier set, configured to indicate at least one index for a starting set of the at least one first sub-carrier, or
an effective sub-carrier number, configured to indicate a number of the first sub-carriers.

As an alternative, the comb resource allocation configuration information comprises at least one of:
a comb size, configured to indicate a value of M,
a start PRB, configured to indicate a first PRB comprising the at least one first sub-carrier,
a PRB length, configured to indicate a number of PRBs comprising the at least one first sub-carrier, or
a sub-carrier offset, configured to indicate the (relative) position of the at least one first sub-carrier within every the M sub-carriers.

In an embodiment, the comb resource allocation configuration information is transmitted in DCI.

In an embodiment, the first wireless signal comprises PDSCH REs or PUSCH REs.

In an embodiment, the second wireless device may receive a reference signal in at least one third sub carrier every K sub-carriers, wherein K is an integer greater than 1. In this embodiment, a relative position of the at least one third sub-carrier within the K sub-carriers is also fixed. Note that K may represent the comb size for the reference signal. In an embodiment, the third sub-carrier(s) is(are) different from the first sub-carrier(s). That is the reference signal may not overlap with other wireless signals.

In an embodiment, the reference signal may be (dedicated) for the second wireless device or shared by multiple wireless device (e.g., the second wireless device and other wireless device(s)).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first wireless device, the method comprising:
transmitting, to a second wireless device, a first wireless signal in at least one first sub-carrier every M sub-carriers, wherein M is an integer greater than 1,
wherein a position of the at least one first sub-carrier within the M sub-carriers is fixed.

2. The wireless communication method of claim 1, further comprising:
transmitting, to the second wireless device, comb resource allocation information associated with the at least one first sub-carrier.

3. The wireless communication method of claim 2, wherein the comb resource allocation configuration information comprises at least one of:
a comb size, configured to indicate a value of M,
a start sub-carrier set, configured to indicate at least one index for a starting set of the at least one first sub-carrier, or
an effective sub-carrier number, configured to indicate a number of the first sub-carriers.

4. The wireless communication method of claim 2, wherein the comb resource allocation configuration information comprises at least one of:
a comb size, configured to indicate a value of M,
a start physical resource block (PRB), configured to indicate a first PRB comprising the at least one first sub-carrier,
a PRB length, configured to indicate a number of PRBs comprising the at least one first sub-carrier, or
a sub-carrier offset, configured to indicate the position of the at least one first sub-carrier within the M sub-carriers.

5. The wireless communication method of claim 2, wherein the comb resource allocation configuration information is transmitted in downlink control information.

6. The wireless communication method of claim 1, wherein the first wireless signal comprises physical downlink shared channel resource elements or physical uplink shared channel resource elements.

7. The wireless communication method of claim 1, further comprising:
transmitting, to a third wireless device, a second wireless signal in at least one second sub-carrier every N sub-carriers, wherein N is an integer greater than 1,
wherein a position of the at least one second sub-carrier within the N sub-carriers is fixed,
wherein the first sub-carrier is different from the second sub-carrier.

8. The wireless communication method of claim 7, wherein M the same or different from N.

9. The wireless communication method of claim 1, further comprising:
transmitting a reference signal in at least one third sub carrier every K sub-carriers, wherein K is an integer greater than 1,
wherein a position of the at least one third sub-carrier within the K sub-carriers is fixed.

10. The wireless communication method of claim 9, wherein the reference signal is for single wireless device or multiple wireless devices.

11. A wireless communication method for use in a second wireless device, the method comprising:
receiving, from a first wireless device, a first wireless signal in at least one first sub-carrier every M sub-carriers, wherein M is an integer greater than 1,
wherein a position of the at least one first sub-carrier within the M sub-carriers is fixed.

12. The wireless communication method of claim 11, further comprising:
receiving, from the first wireless device, comb resource allocation information associated with the at least one first sub-carrier.

13. The wireless communication method of claim 12, wherein the comb resource allocation configuration information comprises at least one of:
a comb size, configured to indicate a value of M,
a start sub-carrier set, configured to indicate at least one index for a starting set of the at least one first sub-carrier, or
an effective sub-carrier number, configured to indicate a number of the first sub-carriers.

14. The wireless communication method of claim 12, wherein the comb resource allocation configuration information comprises at least one of:
a comb size, configured to indicate a value of M,
a start physical resource block (PRB), configured to indicate a first PRB comprising the at least one first sub-carrier,
a PRB length, configured to indicate a number of PRBs comprising the at least one first sub-carrier, or
a sub-carrier offset, configured to indicate the position of the at least one first sub-carrier within the M sub-carriers.

15. The wireless communication method of claim 12, wherein the comb resource allocation configuration information is transmitted in downlink control information.

16. The wireless communication method of claim 11, wherein the first wireless signal comprises physical downlink shared channel resource elements or physical uplink shared channel resource elements.

17. The wireless communication method of claim 11, further comprising:
receiving, from the first wireless device, a reference signal in at least one third sub carrier every K sub-carriers, wherein K is an integer greater than 1,
wherein a position of the at least one third sub-carrier within the K sub-carriers is fixed.

18. The wireless communication method of claim 17, wherein the reference signal is for single wireless device or multiple wireless devices.

19-23. (canceled)

24. A non-transitory computer-readable storage medium having code stored thereupon, the code, upon execution by a processor, causing the processor to implement the wireless communication method of claim 1.

25. A computer program product comprising a computer-readable program medium code stored thereupon, the code, when executed by a processor, causing the processor to implement the wireless communication method of claim 11.
